(19) United States
(12) Patent Application Publication
(10) Pub. No.: US 2013/0212948 A1
(43) Pub. Date: Aug. 22, 2013

(54) OPERATING ASSEMBLY FOR USE WITH AUTOMATIC SLIDING AND FOLDING DOORS

(71) Applicant: Opcon International Holdings, L.P., (US)

(72) Inventor: Angelo Nixon, Carlsbad, CA (US)

(73) Assignee: Opcon International Holdings, L.P., Carlsbad, CA (US)

(21) Appl. No.: 13/741,828

(22) Filed: Jan. 15, 2013

Related U.S. Application Data
(63) Continuation-in-part of application No. 13/228,762, filed on Sep. 9, 2011, now Pat. No. 8,434,266.
Application No. 13/228,762 is a continuation of application No. 12/107,017, filed on Apr. 21, 2008, now abandoned.
(60) Provisional application No. 60/925,488, filed on Apr. 20, 2007.

(51) Int. Cl. E05F 15/10; E05F 15/00

(52) U.S. Cl. CPC E05F 15/10; E05F 15/00
USPC 49/349; 49/360

(57) ABSTRACT

An operating assembly for use with a door is disclosed. The operating assembly has a motor housed in an enclosure that is positioned in a floor cavity. The motor rotates a drive spindle. An actuator assembly is attached to the floor. An actuator track is attached to the enclosure and has a slot configured to receive at least a portion of the drive spindle. A first converter is positioned at one end of the actuator track and is coupled to the drive spindle. A second converter is positioned at the other end of the actuator track. A drive element attached to a bottom surface of the door is positioned in the track. A transfer device couples the first and second converters to the drive element. During operation, the motor rotates the drive spindle and the first converter to move the transfer device to move the drive element and the door.

### CROSS-REFERENCE TO RELATED APPLICATIONS

This application is a continuation-in-part of U.S. patent application Ser. No. 13/228,762, filed Sep. 9, 2011, which is a continuation of U.S. patent application Ser. No. 12/107,017, filed Apr. 21, 2008, which claims the benefit of U.S. Provisional Patent Application Ser. No. 60/925,488, filed Apr. 20, 2007, all of which are hereby incorporated by reference.

### BACKGROUND

The invention relates generally to door operating systems for operating sliding, folding, or swinging doors and, more particularly, to kits for retrofitting generally moisture intolerant door operating apparatuses, typically mounted overhead in standard installations, and particularly for building ingress and egress doors.

Automatic doors are doors that are powered open or powered closed or both. If an automatic door is powered open only, then, it is conventionally spring closed or hydraulically closed. Automatic swing doors conventionally employ a sensor or switch to activate the door. The sensor detects approaching traffic and may be a motion sensor, infrared sensor, or pressure sensor. The switch is conventionally operated manually and may take the form of a push button, swipe card, or other available switch type access or security system. Alternatively the switch may be activated by pushing or pulling the door, so that once the door detects the movement it completes the open and close cycle. These are also known as power-assisted doors.

Swinging doors are hinged and pivot around an axis in an inward or outward direction or both. Automatic swinging doors are coupled to a source of torque, that is, a door operating apparatus, for providing the force necessary to pivot the door open or closed or both. Most commercially available door operating apparatuses are electromechanical or electrohydraulic and are positioned above the door in an overhead position for ease and economy of installation. Most commercially available swing door operating apparatuses are spring closed.

It is sometimes desirable to position the door operating apparatus in a sub-floor stratum The Tormax™ Model TN (Tormax is registered trademark of Landert Motoren AG, BülachZürich, Switzerland) is a floor mounted door operator and is manufactured as an automatic door operator. The Model TN is an underground hydraulic closer with a remotely mounted electric pump system that pushes hydraulic fluid within a floor closer to operate a door. The pump system and electronics are mounted remotely and are not mounted underground. The Model TN is a hydraulic device and is not considered an electromechanical door operating apparatus. The Tormax™ Model TN110 is a floor mounted direct drive operator with a remotely mounted control system that utilizes a motor and gearbox to operate a door. Accordingly, commercially available self-contained electromechanical or hydraulic conversion kits to convert door operating apparatuses that are typically mounted overhead, and to be converted for use underground or in a sub-floor stratum are unknown.

Various devices are known in the art to operate sliding or folding automatic doors. Typically, these operating assemblies are provided overhead. However, in some instances, these overhead assemblies do not fit within a given fenestration in a building because of building code requirements for minimum door opening heights. In addition, overhead assemblies are aesthetically unpleasing. Therefore, it is desirable to have an operating system that is configured for installation either below or within a floor surface or an adjacent wall in order to meet building code requirements and to provide an aesthetically pleasing door system.

### SUMMARY

In an embodiment, an operating assembly for use with a sliding or folding door is disclosed. The operating assembly has a motor assembly that is comprised of a motor and a gearbox. The operating assembly also has a drive spindle adapted to be rotated by the motor. An enclosure houses the motor and is structured and arranged for positioning in a cavity of a surface of a floor. The operating assembly also has an actuator assembly. The actuator assembly has a slotted sway track threshold structured and arranged for attachment to a top surface of the floor. The sway track has opposed first and second ends and a slot that extends substantially along a length of the threshold. A linear actuator track is structured and arranged for attachment to the enclosure and has opposed first and second ends and a slot configured to receive at least a portion of the drive spindle. A first converter is positioned at the first end of the actuator track and is coupled to the drive spindle. A second converter is positioned at the second end of the actuator track. A drive element is positioned in the slot of the sway track and is structured and arranged for attachment to a bottom surface of the door. A transfer device couples the first and second converters to the drive element. During operation, the motor rotates the drive spindle and the first converter to move the transfer device to move the drive element along the slot of the sway track.

In another embodiment, an operating system is disclosed. The operating system has a sliding or folding door and an operating assembly. The operating assembly has a motor and a drive spindle adapted to be rotated by the motor. The motor is housed in an enclosure that is structured and arranged for positioning in a cavity beneath the surface of a floor. A slotted threshold sway track is structured and arranged for attachment to a top surface of the floor. The slotted threshold sway track has opposed first and second ends and a slot that extends substantially along a length of the sway track. A linear actuator track is structured and arranged for attachment to the enclosure. The actuator track has opposed first and second ends and a slot configured to receive a portion of the drive spindle. A first converter is positioned at the first end of the actuator track and is coupled to the drive spindle. A second converter is positioned at the second end of the actuator track. A drive element is positioned in the slot of the sway track and is structured and arranged for attachment to a bottom surface of the door. A transfer device couples the first and second converters to the drive element. During operation, the motor rotates the drive spindle and the first converter to move the transfer device to move the drive element along the slot of the sway track to move the door.

In another embodiment, an operating assembly for use with a door is disclosed. The operating system has a motor and a drive spindle adapted to be rotated by the motor. An enclosure is adapted to house the motor. The enclosure is structured and arranged for vertical positioning in a cavity in an adjacent structure such as a door jam or wall. The operating assembly has an actuator assembly. The actuator assembly has a slotted sway track structured and arranged for attachment to a top surface of a floor. The sway track has opposed first and second ends and a slot that extends substantially along a length of the threshold. An actuator track is structured and arranged for attachment to the top surfaced of the floor. The actuator track has opposed first and second ends and a slot configured to receive a portion of the drive spindle. A first converter is positioned at the first end of the actuator track and is coupled to the drive spindle. A second converter is positioned at the second end of the actuator track. A drive element is positioned in the slot of the sway track and is structured and arranged for attachment to a bottom surface of the door. A transfer device couples the first and second converters to the drive element. During operation, the motor rotates the drive spindle and the first converter to move the transfer device to move the drive element along the slot of the sway track.

In another embodiment, an operating assembly for use with a door is disclosed. The operating assembly has a motor and a drive spindle adapted to be rotated by the motor. An enclosure is adapted to house the motor and is structured and arranged for positioning in a cavity in a surface of a floor. The operating assembly also has an actuator assembly. The actuator assembly has a spindle passing through a first hole of the enclosure to engage a bottom surface of the door. A converter is coupled to the spindle. During operation, the motor rotates the spindle and the first converter to rotate the spindle to move the door between the open and closed positions.

Other objects, features, aspects, and advantages of the operating assembly will become better understood or apparent from the following detailed description, drawings, and appended claims.

### BRIEF DESCRIPTION OF THE DRAWINGS

The objects, advantages, and features of the invention, as shown in the exemplary embodiments, will be more clearly perceived from the following description, when read in conjunction with the accompanying drawings, in which:

FIG. 1 is an exploded perspective view illustrating both a swing door operating apparatus and a door operating system (shown in phantom) and all components of an exemplary kit for retrofitting both the door operating apparatus and door operating system to underground use, illustrating all components of the exemplary kit that serve as positional adjustment mechanisms;

FIG. 2 is a plan view illustrating the closed position of a swing door, a door arm, and a retrofitted door operating apparatus illustrated in FIG. 1;

FIG. 3 is a sectional view taken through cutting plane 3-3 of FIG. 2, illustrating an exemplary retrofitting kit having a plate threshold and all sealing arrangements in accordance with the invention;

FIG. 4 is an enlarged fragment of the sectional view of FIG. 3 illustrating cross sections of two sealing rings and their associated O-rings for sealing the spindle, the upper sealing ring being sealed to the plate threshold with a sealant layer and the lower sealing ring being sealed to the upper portion of the enclosure with another sealant layer, and contrasting the sealing rings with the metal bearing ring associated with the top plate;

FIG. 5 is a further enlarged portion of the sectional view of FIG. 2 illustrating the lateral adjusting screw and the gasket sandwiched between the rims of the upper and lower portions of the enclosure;

FIG. 6 is a sectional view illustrating an alternative embodiment of the retrofitting kit having a flat flooring, “pan-type” threshold rather than a plate threshold, as illustrated in FIG. 3;

FIG. 7 is an exploded view of an embodiment of a sliding or folding door operating assembly;

FIGS. 8A-8D illustrate partially assembled views of the operating assembly shown in FIG. 7;

FIGS. 9A-9C are isometric views of embodiments of actuator assemblies;

FIGS. 10A-10C are exploded views of sliding or folding doors in combination with the embodiments of the operating assemblies shown in FIGS. 9A-9C, respectively, where FIG. 10A shows a dual sliding door, FIG. 10B shows a folding door, and FIG. 10C shows a single sliding door;

FIG. 11 is cross-sectional end view of the operating assembly shown in FIG. 7;

FIG. 12 is an exploded view of a folding door installation that includes a side mounted operating system and a linear actuator (12A) or a right angle gearbox (12B);

FIG. 13 is a plan view illustrating the partially closed position of a folding door, a door arm, and a retrofitted door operating apparatus illustrated in FIG. 1; and

FIG. 14A is a front elevation view illustrating a folding door in the closed position in combination with the operating assembly illustrated in FIGS. 1-6; FIG. 14B is an end view of the door and operating assembly illustrated in FIG. 14A; FIG. 14C is a plan view illustrating a folding door in the open position.

### DETAILED DESCRIPTION

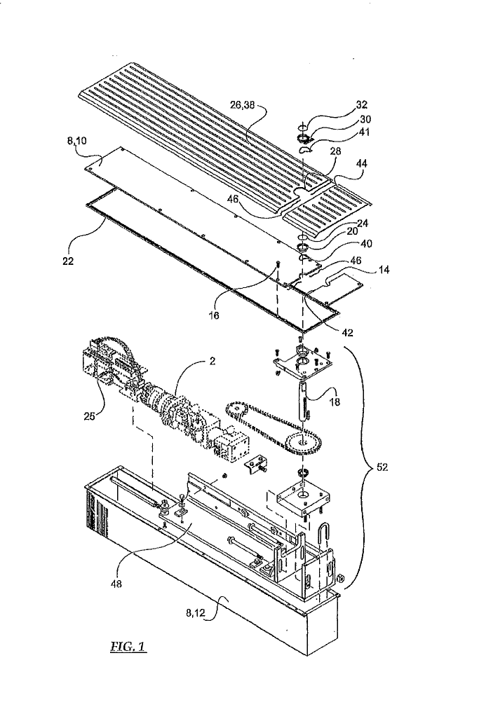

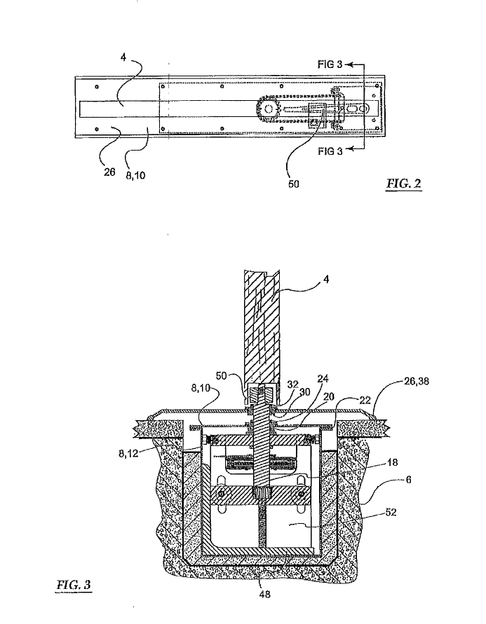

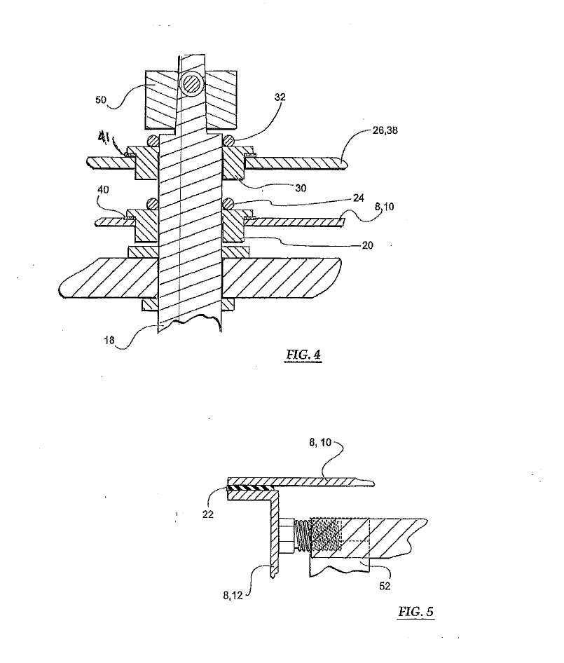

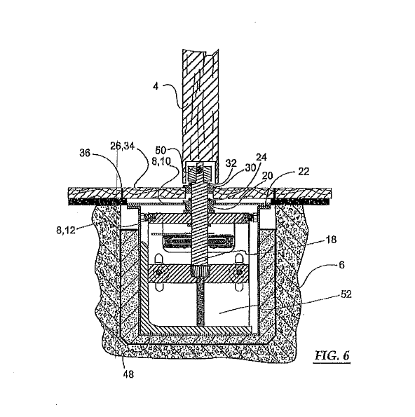

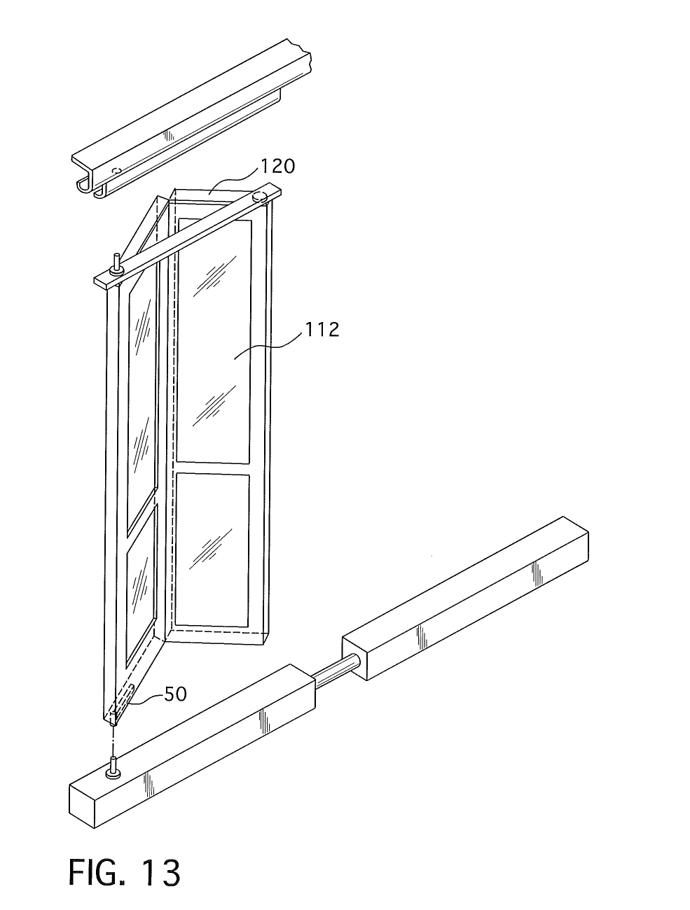

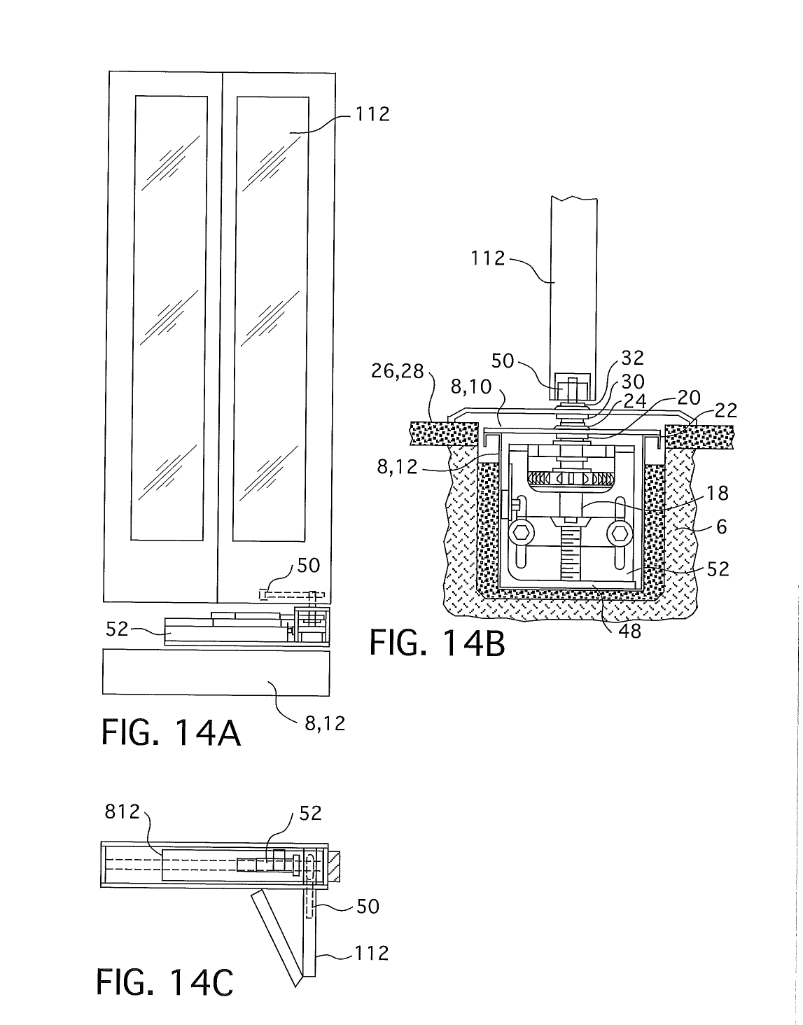

FIGS. 1-6, 13, and 14 illustrate an example of a retrofit conversion kit for coupling a door operating apparatus (2) to a swinging door (4) (FIGS. 1-6) or a folding door (112) (FIGS. 13-14) for operating the swinging door (4) or folding door (112) from a sub-floor stratum (6) and for sealing the door operating apparatus (2) within the sub-floor stratum (6). In FIG. 14A, cement case (8, 12) is shown below the operating assembly (52) for clarity. In a preferred mode, the door operating apparatus (2) is electromechanical or is otherwise of a type that is generally intolerant to moisture. The door operating apparatus (2) is of a type that is designed for operation from a position other than the sub-floor stratum (6). Typically, the retrofit conversion kit can be employed for converting the door operating apparatus (2) from overhead use to underground use.

The retrofit conversion kit includes an enclosure (8) for containing the door operating apparatus (2). The enclosure (8) includes an upper portion (10) and a lower portion (12). The upper and lower portions (10 and 12) of the enclosure are made of a moisture impervious material, including for example, cement, galvanized steel, stainless steel, or a composite material. The upper and lower portions (10 and 12) of the enclosure are attachable and detachable to and from one another for providing access for installing and adjusting the door operating apparatus (2) within the lower portion (12) of the enclosure and may be secured, for example, with liquid concrete such as “Quik-Crete®” or “Pour-Stone.” The lower portion (12) of the enclosure is anchorable within the sub-floor stratum (6). The upper portion (10) of the enclosure defines a first hole (14). One or more fasteners (16) are provided for fastening and unfastening the upper and lower portions (10 and 12) of the enclosure. Preferred fasteners (16) are press-fitted rivet nuts, machine pressed into the lower enclosure portion (12), with machine screws inserted through the fastening holes (16) in the upper enclosure portion (10). The retrofit conversion kit also includes a spindle (18). The spindle (18) is adapted for rotationally engaging the door operating apparatus (2) within the enclosure (8). The spindle (18) is also adapted for passing through the first hole (14) of the enclosure (8) for vertically and rotationally engaging the swinging door (4) or the folding door (112) both for providing vertical support to the swinging (4) or folding door (112) and for transmitting torque from the door operating apparatus (2) to the swinging (4) or folding door (112).

The retrofit conversion kit also includes various sealing arrangements. An embodiment of a sealing arrangement is illustrated in FIG. 1. A first sealing ring (20) encircles the first hole (14) and forms a moisture tight seal with the upper portion (10) of the enclosure. The first sealing ring (20) is adapted for providing both passage of the spindle (18) through the first hole (14) and rotational freedom of the spindle (18) within the first hole (14) while simultaneously forming a moisture tight seal between the spindle (18) and said first sealing ring (20). The first sealing ring (20) also provides lateral support between the enclosure (8) and the spindle (18). In a preferred embodiment, the first sealing ring (20) has a composition of self-lubricating thermoplastic. A gasket (22) is positioned between the upper and lower portions (10 and 12) of the enclosure for making a moisture tight seal therebetween when the upper and lower portions (10 and 12) of the enclosure are attached to one another by one or more of the fasteners (16). In an embodiment, the gasket (22) has a vinyl, rubber, cork, or other composition suitable for use therefore.

When the retrofit conversion kit is fully assembled and installed within a sub-floor stratum (6), the enclosure (8) provides an overall moisture tight containment of the door operating apparatus (2) when operating from the sub-floor stratum (6).

The sealing arrangements taken together and in combination with the other structural elements of the retrofit conversion kit also serve a surprising mechanical function. Under normal use conditions, bearings in the bearing plate and in the top plate provide lateral support to the spindle (18) to cope with lateral forces upon the swinging (4) or folding (112) door. However, when excess lateral force is applied to the swinging (4) or folding (112) door, the structural support for these bearings can contort. In these instances, the first sealing ring (20) can take on a temporary bearing function and can provide additional lateral support to the spindle (18) and to the door (4, 112) when the width of the first sealing bearing (20) is expanded laterally to attach to the enclosure (8, 10) through existing holes using the typical fasteners. The lateral bearing force borne by the first sealing ring (20) is transferred to the enclosure (8) anchored to the sub-floor stratum (6). Hence, the first sealing ring (20) can provide occasional mechanical functions, as well as maintaining its sealing function.

In the illustrated retrofit conversion kit, the first sealing ring (20) includes a first O-ring (24) for contacting the spindle (18) for facilitating the formation of the moisture tight seal between the first sealing ring (20) and the spindle (18). In one embodiment, an automatic door operator system (25) is coupled to the door operating apparatus (2) and is enclosed therewith within the enclosure (8). When the enclosure (8) is sealed, it provides an overall moisture tight containment of the door operating apparatus (2) and the automatic door operator system (25) coupled thereto when operating from the sub-floor stratum (6).

In another embodiment, the retrofit conversion kit further comprises a threshold cover (26) for spanning over the enclosure (8), the threshold cover (26) defining a second hole (28) for accommodating the passage of the spindle (18) therethrough. This threshold cover (26) includes a second sealing ring (30) that encircles the second hole (28) and forms a moisture tight seal with the threshold cover (26). The second sealing ring (30) is adapted for providing both passage of the spindle (18) through the second hole (28) and rotational freedom of the spindle (18) within the second hole (28) while simultaneously forming a moisture tight seal between the spindle (18) and said second sealing ring (30). In one embodiment, the second sealing ring (30) has a composition of self-lubricating thermoplastic. The second sealing ring (30) preferably includes a second O-ring (32) for contacting the spindle (18) for facilitating the formation of the moisture tight seal between the second sealing ring (30) and the spindle (18). In one embodiment, the optional threshold cover (26) is flooring material (34), such as stone, terrazzo, tile, carpet, etc. (FIG. 6). In this instance, the flooring material (34) may further include silicone joint material (36) attached thereto for forming a moisture tight seal between the flooring material (34) and the sub-floor stratum (6) and/or with a floor above the sub-floor stratum (6). In another embodiment, the optional threshold cover (26) is a flat transition plate (38) without the typical sloping edges of a threshold. This flat plate transitions between interior and exterior flooring in a level plane, thus allowing smoother ingress and egress for wheelchairs and other wheeled vehicles.

In another embodiment, the door operating apparatus (2) is of a type that requires power from an external electric power line or requires an electrical connection between multiple door operating apparatuses. In this instance, the installer forms an opening in the enclosure (8) for passing the electric power line thereinto for powering the door operating apparatus (2). In a preferred mode, the seal integrity of the enclosure (8) is maintained by using liquid-tite electrical fittings that offer an internal gasket within the fitting that attaches to the enclosure by bolting.

A process for coupling a swinging door (4) or a folding door (112) to a door operating apparatus (2) from a sub-floor stratum (6) in also shown. In one mode, the door operating apparatus (2) is of a type that is electromechanical and generally moisture intolerant and designed for operation from a position other than a sub-floor stratum (6). A lower portion (12) of an enclosure is anchored within the sub-floor stratum (6). The door operating apparatus (2) and a coupling device are installed within the lower portion (12) of the enclosure. The door operating apparatus (2) and a coupling device are rotationally coupled to one another. The coupling device includes a spindle (18) for rotationally coupling to the swinging door (4) or the folding door (112). The door operating apparatus (2) and the coupling device are sealed within the enclosure (8) with a moisture tight seal by attaching an upper portion (10) of the enclosure to the lower portion (12) of the enclosure with a gasket (22) therebetween while simultaneously providing for a moisture tight rotationally free passage of the spindle (18) through the upper portion (10) of the enclosure. Then, the spindle (18) is vertically and rotationally engaged with the swinging door (4) or folding door (112) for providing vertical support to the swinging (4) or folding (112) door and for transmitting torque from the door operating apparatus (2) to the swinging (4) or folding (112) door. In the assembled state, the enclosure (8) provides an overall moisture tight containment of the door operating apparatus (2) when operating from the sub-floor stratum (6).

### EXAMPLE

FIGS. 1-6, 13, and 14 illustrate a kit for converting any manufacturer's overhead mounted swinging (FIGS. 1-6) or folding (FIGS. 13-14) door apparatus from overhead use to underground use. The kit protects the door operating apparatus (2) against moisture and dust encroachment within its underground location. More particularly, the illustrated example includes a water tight sealing ring (20) for sealing the spindle (18) within the enclosure (8) and a water tight gasket (22) for sealing the two halves of the enclosure (8). In embodiments, the gaskets (22) may have a vinyl, rubber, or cork composition. This sealing system renders the enclosure (8) watertight and enables the door operating apparatus (2), including its electronic components, to be self-contained and protected against water and dust encroachment within the enclosure (8). Use of this sealing system as part of the conversion kit referred to above affords the first conversion kit that enables an overhead electromechanical automatic door operating apparatus to be converted for use in a sub-floor position within a self-contained enclosure (8) that is sealed against moisture and dust encroachment. This sealing system can be unsealed to provide access to the underground components for maintenance or adjustments and can be re-sealed without compromising the integrity of the seal. The sealing system is reusable and permits continual access within the enclosure (8) to the components of the automatic door operating apparatus (2) and system (25), and provides a moisture-tight self-contained enclosure (8), while permitting rotation of the apparatus spindle (18). The door (4, 112) does not need to be removed to perform maintenance or adjustments.

In the illustrated embodiment, the sealing system includes a first (20) or second (30) sealing ring or both. The first sealing ring (20) is mounted with a moisture-tight fit in the first hole (14) of the upper portion (10) of the enclosure through which the spindle (18) exits. In an embodiment, the moisture tight fit may be achieved by mechanically pressing the sealing ring (20) into the upper portion (10) of the enclosure. In another embodiment, the moisture tight fit may be achieved by the application of a layer (40) of sealant between the surface of the enclosure (8) and the sealing ring (20). In an embodiment, a sealant (40) for forming this layer may be a commercially available viscous sealant paste that develops into a semi-flexible seal for increasing the reliability of gasket seals, such as Permatex™ Form-A Gasket™ No. 2 Non-Hardening Sealant (“Permatex™”, and “Form-A-Gasket™” are trademarks of Permatex, Inc., Hartford, Conn.). The second sealing ring (30) is mounted with a water tight seal in the second hole (28) of the threshold cover (26) through which the spindle (18) exits. This moisture tight fit can be achieved by the application of a layer (41) of sealant between the surface of the threshold cover (26) and the second sealing ring (30). A preferred sealant for forming this layer (41) is the same as sealant (40). If the first and second sealing rings (20 and 30) are employed with a retrofit kit having an adjustable spindle location (as described in co-pending patent application Ser. No. 12/107,018 entitled “Adjustable Spindle Arrangement for Door Operating Apparatus Retrofit Kit, filed Apr. 21, 2008, incorporated herein by reference), the first and second sealing rings (20 and 30) are aligned with the spindle in its desired location before they are mounted with the layer of sealant (40 and 41, respectively).

In a first variant of this embodiment, the upper portion (10) of the enclosure includes a splice (42) that bisects the first hole (14) for facilitating the disassembly of the upper portion (10) of the enclosure for providing access to the door operating apparatus (2) therein. In second variant of this embodiment, the threshold cover (26) includes splice (44) that bisects the second hole (28) for facilitating the disassembly of the threshold cover (26) for providing access to the door operating apparatus (2) therein. Both the first and second variants may be employed simultaneously to achieve optimal access to the door operating apparatus (2). With either or both variants, the splices are sealed by the application of silicone sealant (46).

The preferred compositions for the sealing rings (20 and 30) are self-lubricating high performance engineering thermoplastics characterized by their dimensional stability, low friction, stiffness, and fatigue, corrosion, and wear resistance, such as polyoxymethylene (a polymer with the chemical formula —(—O—CH₂—)ₙ—), commonly known under the brand name of Delrin® (Delrin® is a registered trademark of E.I. du Pont de Nemours and Company, Delaware), or such as polyamide (nylon). It was found that conventional off-the-shelf seal products such as bearing seals and sheet vinyl cut to fit these holes were ineffective for this application because they become damaged when the spindle (18) is turned so as to permit leakage when exposed to water. Also, they were not reusable, that is, if the enclosure (8) is accessed for servicing the door operating apparatus (2) therein, the seals tended to become damaged so as to become leaky. Also, although conventional shaft seals are available for containing liquids in machinery and equipment, these seals are not designed for protecting electronics and mechanical components in a wet-weather environment typical of many floor surfaces and/or in dusty environments which often pertain with building ingress and egress. Also, these conventional shaft seals are not designed for repeated assembly and disassembly with respect to the exiting shaft. In contrast, sealing rings (20 and 30) in accordance with the invention having a composition of self-lubricating thermoplastic products are much less subject to damage by repeated rotations of the spindle (18), or by accessing the interior of the enclosure (8), or both, and exhibit much superior performance with respect to maintenance of the integrity of the seal. Performance of the sealing rings (20 and 30) is further enhanced by addition of an “O” ring. The first sealing ring (20) is attached to the upper portion (10) of the enclosure and thereby helps spread the lateral forces exerted on the spindle (18) over a larger area of the entire enclosure (8) so as to help secure the mounting sled (48) assembly to the enclosure (8). In an embodiment, sealing rings (20 and 30) having a composition of self-lubricating thermoplastic products.

All necessary operating components are enclosed within the enclosure (8) so that there is no need for any components to be remotely mounted or remotely interfaced. The operating components can include expensive control systems and computers that are highly sensitive to moisture and dust encroachment. In many construction situations, there simply is not enough unused and available area to remotely mount electronic equipment for use with a sub-floor automatic door operating apparatus (2). This is a particularly important with monumental, all-glass swinging doors and with historic preservation type doors. Additionally, voltage drops can occur with remote mounting of the electronics and low voltage signal strength can be compromised if long wiring is employed between the torque mechanism and the remotely mounted operator control systems. The market has become accustomed to the electronics provided with commercially available automatic door operators being mounted within the enclosure. The kit provides a self-contained operating system.

Use of the kit for retrofitting a door operating apparatus (2) disclosed herein results in greater reliability and longevity of the electronic and mechanical components of the door operating apparatus (2) and the automatic door operating system (25) sealed within the enclosure (8). Water, moisture, and dust encroachment can be greatly reduced, and even substantially eliminated.

Use of the kit for retrofitting a door operating apparatus (2) disclosed herein results in easier maintenance and service calls due to the ready access to the interior of the sealed enclosure (8) for servicing the components therein. It also reduces the cost because the sealing rings (20 and 30) do not need to be replaced each time the enclosure (8) is accessed, nor does the door (4, 112) need to be removed.

Use of the kit for retrofitting a door operating apparatus (2) disclosed herein results in enhanced aesthetics because installation in a sub-floor stratum (6) can render the apparatus almost unnoticeable. The kit provides a self-contained operating system.

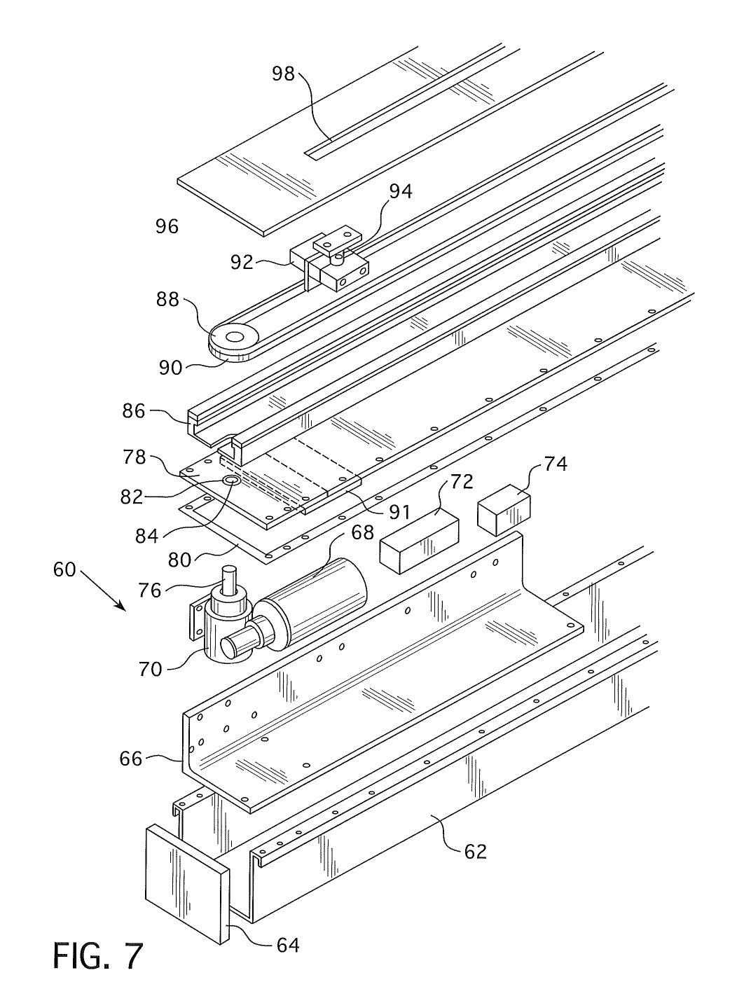

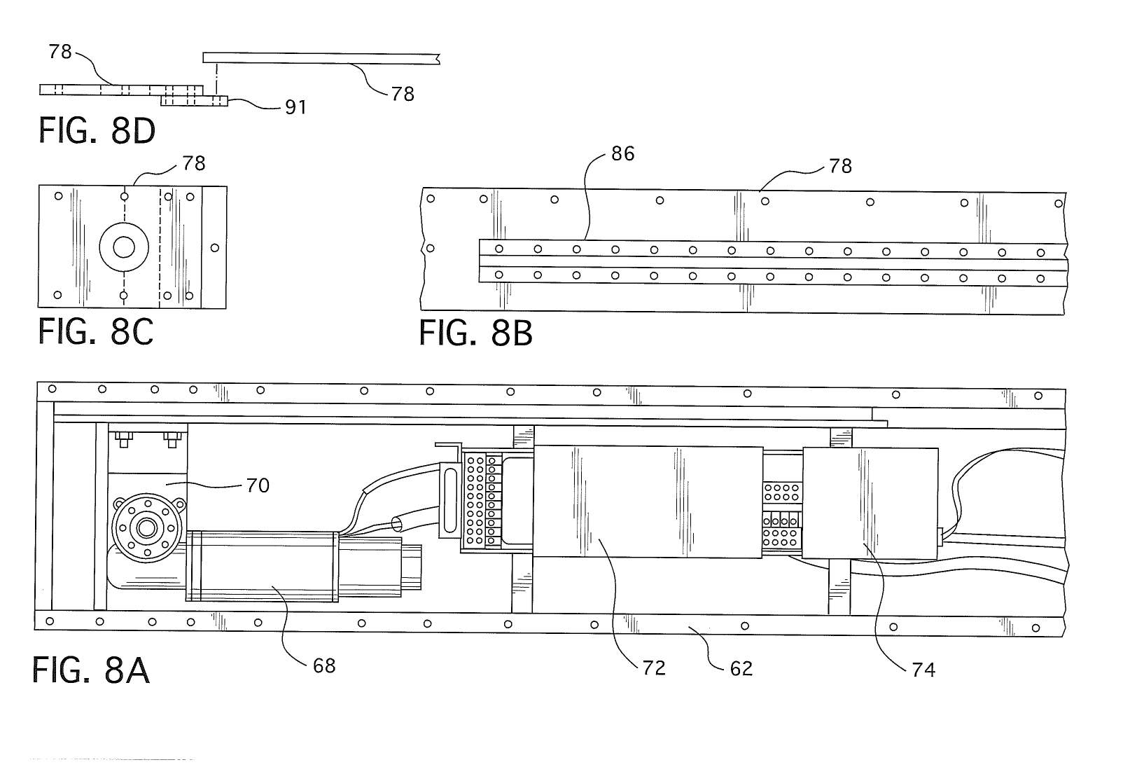

FIG. 7 is an exploded view of a portion of an embodiment of an operating assembly (60) for use with a sliding or folding door. FIG. 8 is a plan view of a portion of the operating assembly shown in FIG. 7. As illustrated in FIGS. 7 and 8, the operating assembly includes an enclosure (62) configured to be mounted below a door, for example, in a floor or other structure below a door or doorway threshold. The enclosure is also referred to as a cement case and includes an end plate (64). A chassis (66) is configured to fit within the enclosure. Several components can be mounted to the chassis, including a motor assembly comprising a motor (68) and gear box (70); an electronic controller (72); and a transformer or other electronic component (74). A spindle shaft (76) extends from the gear box. In various examples, the motor (68) may be electric, electronic, hydraulic, or pneumatic and may be a reversible motor.

As illustrated in FIGS. 8A-8D, a cement case cover (78) and cement case cover gasket (80, as shown in FIG. 7) are configured to mount onto the cement case and prevent (or minimize the probability of) moisture or contaminants from entering the cement case. As illustrated in FIG. 8B, the linear actuator track (86) is mounted to the cement case cover (78) using blind holes so as not to penetrate the cover (78). Optionally, as illustrated in FIG. 8D, cement case cover (78) may be two parts that are connected by a shelf plate (91) that is positioned below the two pieces of the cement case cover (78). In embodiments, cement case cover gasket (80) may be made of vinyl, foam, cork, or rubber composition. In an assembled and installed state, the cement cover (78) provides an overall self-contained moisture tight containment of the motor (68), gear box (70), controller (72), and transformer (74), and any auxiliary components such as timers or relays.

One or more fasteners (not shown) are provided for fastening and unfastening the cement case cover (78) from the cement case, including for example press-fitted rivet nuts, machine pressed into the cement case, with machine screws inserted through the fastening holes in the cement case cover. The cement case and cover are made of moisture impervious material and are attachable and detachable from one another for providing access to the motor (68), gear box (70), controller (72), and transformer (74) housed in the cement case. The cement case cover includes an opening (82) through which the spindle shaft (76) passes. A spindle seal (84) is provided around the spindle shaft in, or adjacent to, the opening (82). In an embodiment, the spindle seal (84) may have a composition of self-lubricating thermoplastic, or a pressed-in self-lubricating seal.

A linear actuator track (86) is configured to be mounted on top of the cement case cover. A converter and a transfer device is positioned in the track. In the embodiments illustrated in the figures, the converter may be a drive pulley (88) and the transfer device may be a belt (90). The drive pulley is coupled to the spindle shaft, such that rotation of the shaft moves the belt and thereby moves a travel block (92) that is attached to the belt. In another embodiment, the converter may be in the form of gears having teeth and the transfer device may a tooth belt (not shown). In another embodiment, the converter may be a sprocket and the transfer device may be a chain (not shown). In another embodiment the converter may be a linear actuator and the transfer device may be a screw-drive (not shown).

The travel block (92) supports a drive element/breakaway pivot (94) that is configured to engage a door. Optionally, the drive element/breakaway pivot (94) is configured to include a breakout pin, latch assembly, or the like (not shown) for use with either a sliding (100, 102) or a folding (112, 114) door to enable the drive element/breakaway pivot (94) to disengage from the door (100, 102, 112, 114) in an emergency. A threshold sway track (96) is mounted above the linear actuator track and includes a linear slot (98) through which the drive element (94) passes. Movement of the drive element (94) operates the door.

The operating assembly (60) may be structured and arranged to be positioned in a cavity formed beneath a surface of a floor. With the exception of the drive element (94) and the threshold sway track (96), the entire operating assembly (60) may be positioned within the cavity, including the motor (68) and the linear actuator track (86). The cavity may have a conduit for power and a conduit for low voltage control components.

The operating assembly (60) may be configured for use in new construction or in existing construction to retrofit a conventional overhead mounted system to an underground mounted system. Accordingly, the operating assembly (60) eliminates the need for conventional overhead mounted operating systems. In various embodiments, the operating assembly (60) enables the installation of automatic sliding or folding doors in building entries that are not tall enough to accept a conventional overhead operating automatic door system or where an overhead mounted system is not aesthetically pleasing.

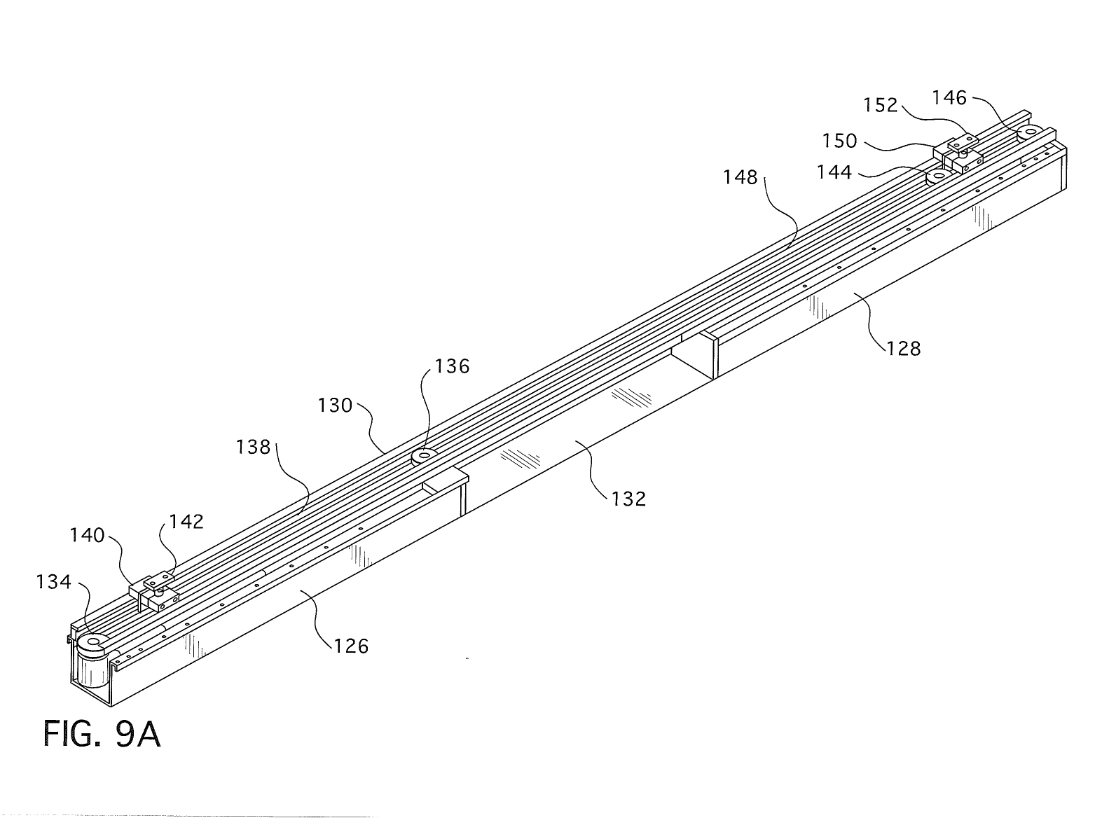

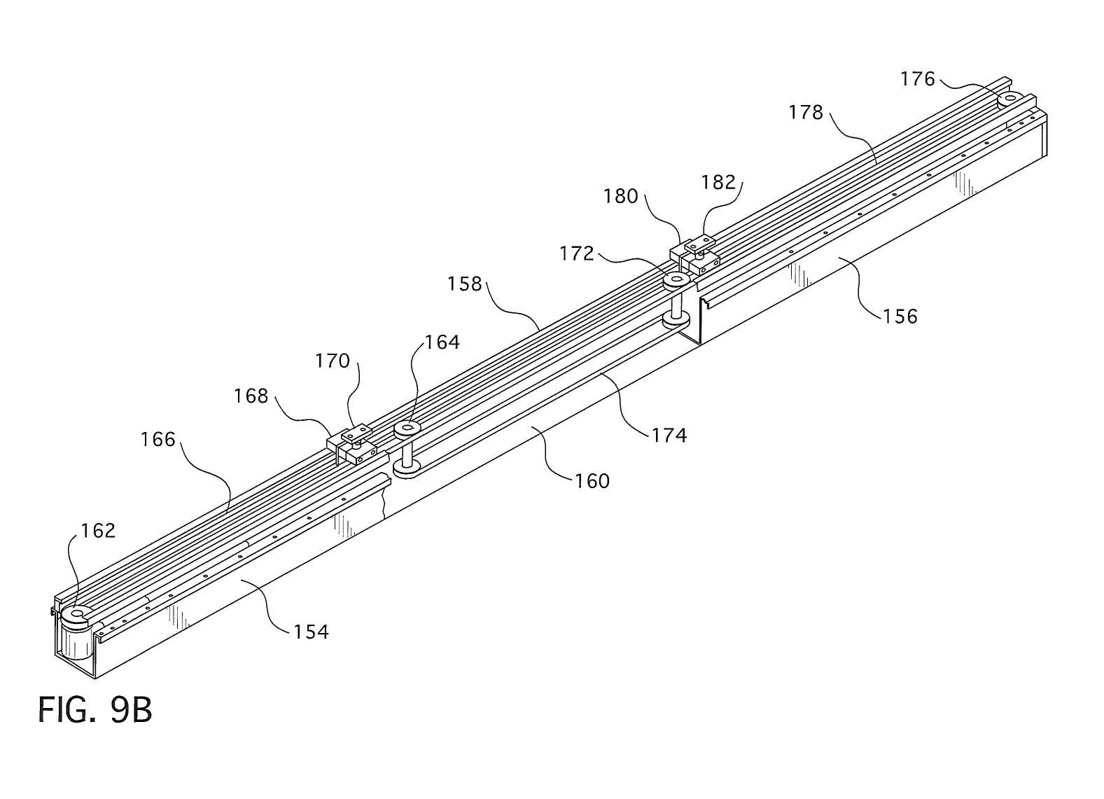

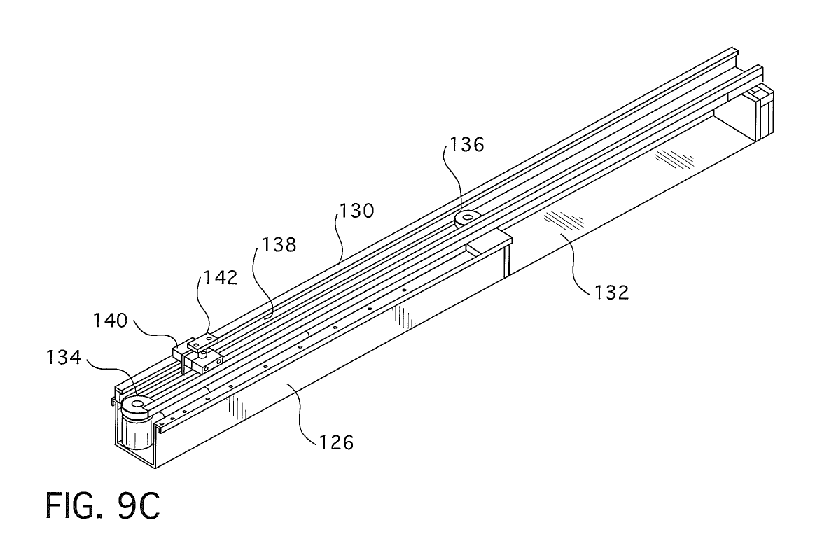

FIGS. 9A through 9C are isometric views of portions of additional embodiments of a linear actuator assembly. FIG. 9A includes two cement cases (126) and (128) that each can include a drive motor and associated electronic elements similar to those described in FIG. 7. A linear slotted track (130) extends over both cement cases and a space (132) between the cement cases. The cement cases can be embedded in cement or other structural material in a floor or door threshold. A first drive pulley (134) is coupled to a first idler pulley (136) by a first belt (138). A first travel block (140) is attached to the first belt. The first travel block supports a drive element/breakaway pivot (142) that is configured to engage a door. A second drive pulley (144) is coupled to a second idler pulley (146) by a second belt (148). A second travel block (150) is attached to the belt. The second travel block supports a drive element/breakaway pivot (152) that is configured to engage a door.

FIG. 9B includes two cement cases (154) and (156), wherein cement case (154) can include a drive motor and associated electronic elements similar to those described in FIG. 7. A linear slotted track (158) extends over both cement cases and a space (160) between the cement cases. The cement cases can be embedded in cement or other structural material in a floor or door threshold. A first drive pulley (162) is coupled to a first idler pulley (164) by a first belt (166). A first travel block (168) is attached to the first belt. The first travel block supports a drive element/breakaway pivot (170) that is configured to engage a door. A second idler pulley (172) is coupled to the first idler pulley (164) by a second belt (174). A third idler pulley (176) is coupled to the second idler pulley (172) by a third belt (178). A second travel block (180) is attached to the third belt (178). The second travel block supports a drive element/breakaway pivot (182) that is configured to engage a door. In the embodiment of FIG. 9B, a single drive motor operates both travel blocks.

FIG. 9C includes a single cement case (126) that includes a drive motor and associated electronic elements similar to those described in FIG. 7. A linear slotted track (130) extends over the cement case and a space (132) lateral to the cement case. The cement case can be embedded in cement or other structural material in a floor or door threshold. A drive pulley (134) is coupled to an idler pulley (136) by a belt (138). A travel block (140) is attached to the belt. The travel block supports a drive element/breakaway pivot (142) that is configured to engage a door.

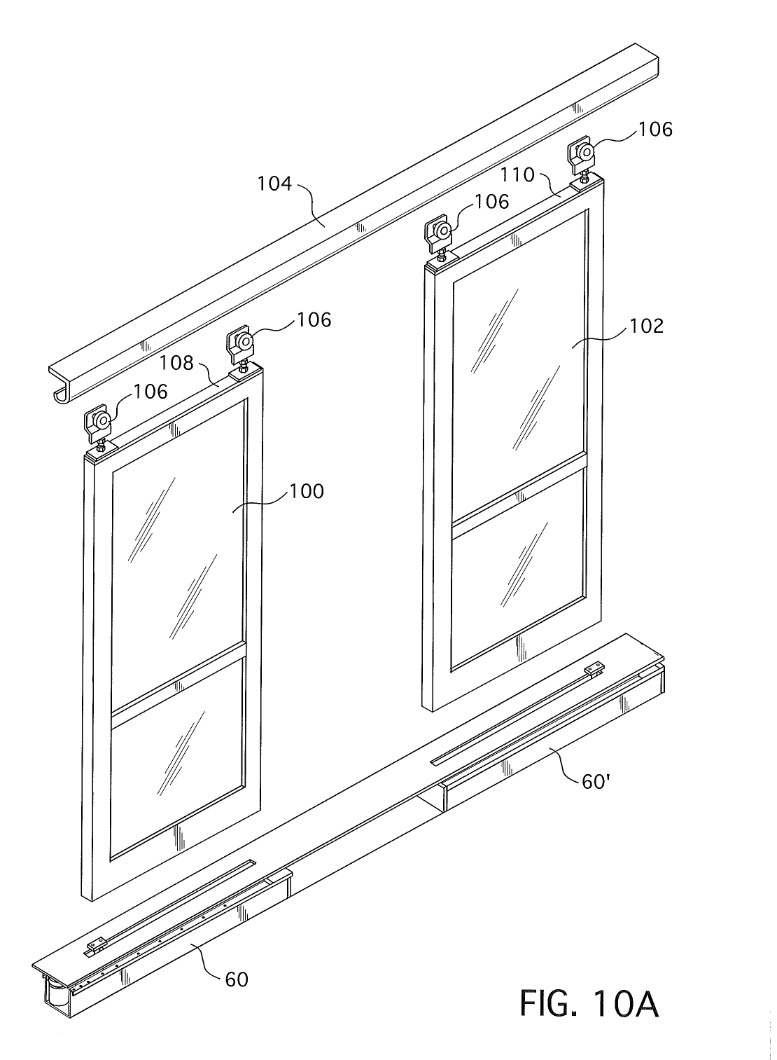

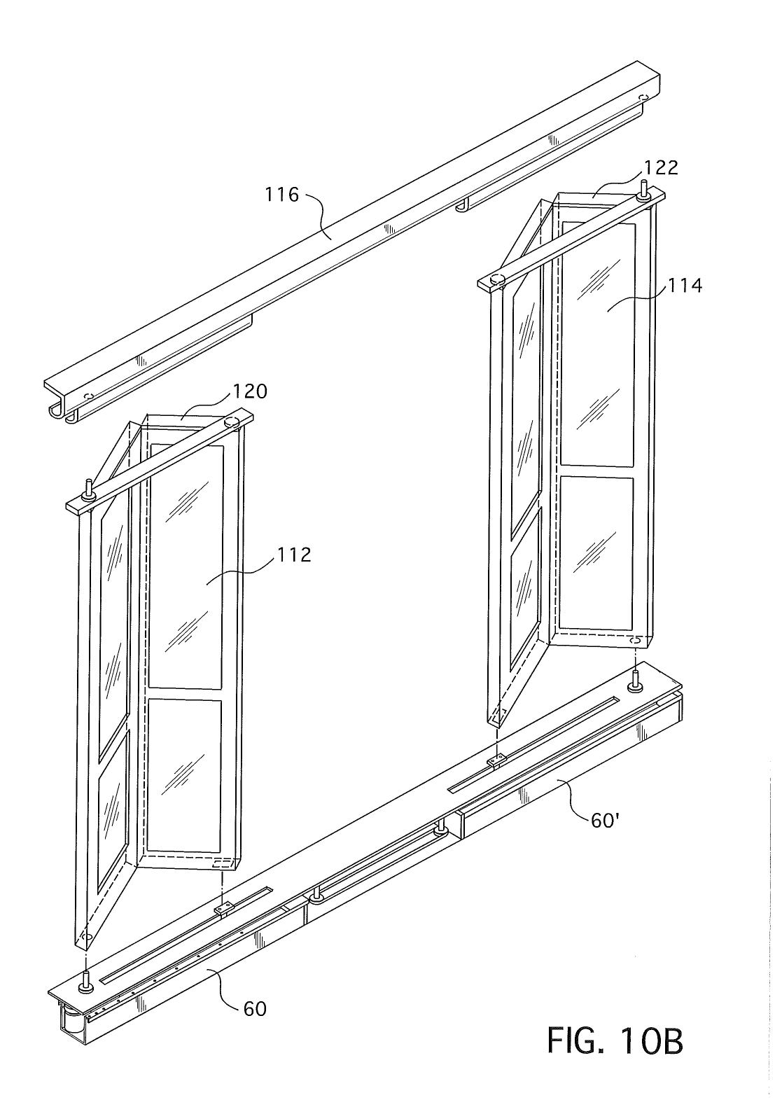

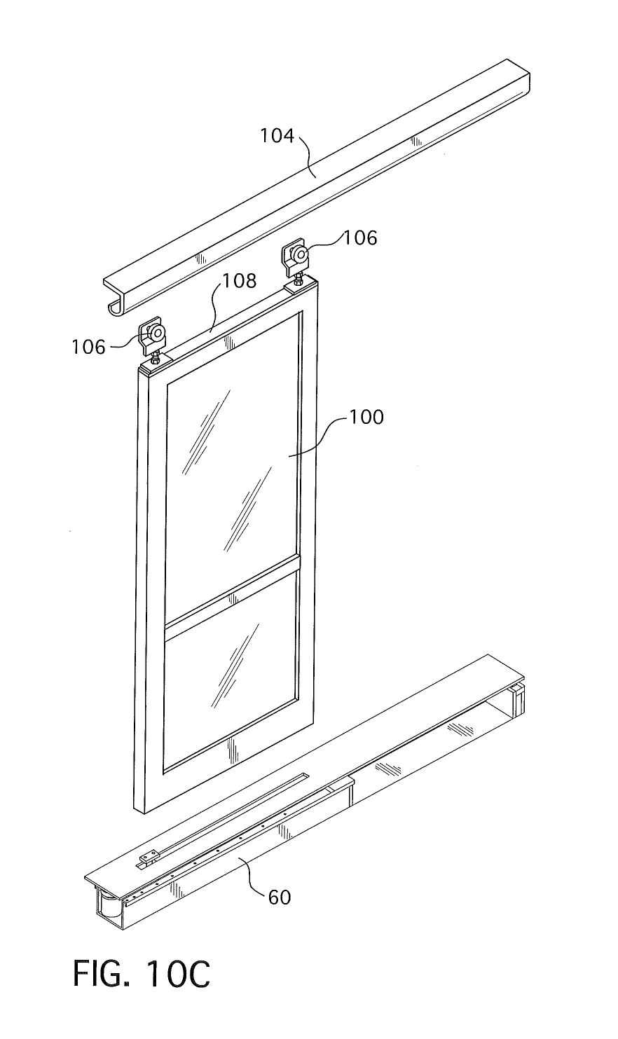

FIG. 10A is an exploded view of an installation including two sliding door panels (100) and (102), each coupled to an operating assembly (60) and (60′), respectively, such as those illustrated in FIG. 9A. The doors (100, 102) are coupled to low profile header/carrier (104) by way of wheels or linear actuator sliders (106). Breakaway arms (108) and (110) are provided adjacent to the tops of the sliding door panels. Although FIG. 10A shows the operating assemblies (60) and (60′) in combination with two sliding door panels (100, 102), the operating assemblies may also be used in combination with two folding doors such as folding doors (112) and (114) illustrated in FIG. 10B.

FIG. 10B is an installation including two folding door panels (112) and (114), each coupled to an operating assembly (60) and (60′), respectively, such as those illustrated in FIG. 9B, and shown in the partially closed position. The doors are coupled to low profile header/carrier (116) by way of wheels or linear actuator sliders (118). Breakaway arms (120) and (122) are provided adjacent to the tops of the folding door panels. Although FIG. 10B shows the operating assemblies (60) and (60′) in combination with two folding door panels (112, 114), the operating assemblies may also be used in combination with two sliding doors such as sliding doors (100) and (102) illustrated in FIG. 10A.

FIG. 10C is an exploded view of an installation including a single slider door (100) coupled to an operating assembly (60) such as the one as illustrated in FIG. 9C. The door is coupled to a low profile header/carrier (104) by way of wheels (106) or linear actuator sliders (not shown). Breakaway arms (108) and (110) are provided adjacent to the top of the sliding door (100). Although FIG. 10C shows the operating assembly (60) in combination with a sliding door panel (100), the operating assembly may also be used in combination with a single folding door such as folding door (112) illustrated in FIG. 10B.

As illustrated in the figures, the operating assembly is configured for use with a sliding (FIGS. 10A, 10C) or a folding (FIG. 10B) door. In FIGS. 10A and 10B, the doors are adapted to at least partially fill a door opening defined by the surface of the floor and a door frame having at least one side and a top. In an embodiment, the door can be a single panel that is adapted to fill the door opening (10C). In another embodiment, the door includes first and second panels that are positioned adjacent to each other to fill the door opening (FIGS. 10A and 10B). In an embodiment, each door panel is operated by an operating assembly (FIG. 10A). Optionally, in embodiments where there is more than one door panel and more than one operating assembly, a single motor operates both door panels and the operating assembly optionally includes a device (162, 172, 174) to move the door panels in opposite directions along the slotted threshold (FIG. 10B). The door is movable between a closed position and an open position. In the closed position, the door is disposed in proximity to the sides of the door frame and substantially fills the opening. In the open position, the door is displaced from at least one of the sides of the door frame to permit access through the opening.

Referring to FIGS. 10A through 10C, the operating assembly includes a carrier that is structured and arranged for attachment to a fenestration and a top surface of the door to couple the door to the fenestration. The carrier can be structured and arranged to support substantially all of the weight of the door when the door is attached to the carrier. In an embodiment, the carrier includes a track and a trolley. A first end of the trolley can be positioned in the track and a second end of the trolley can be attached to the top surface of the door.

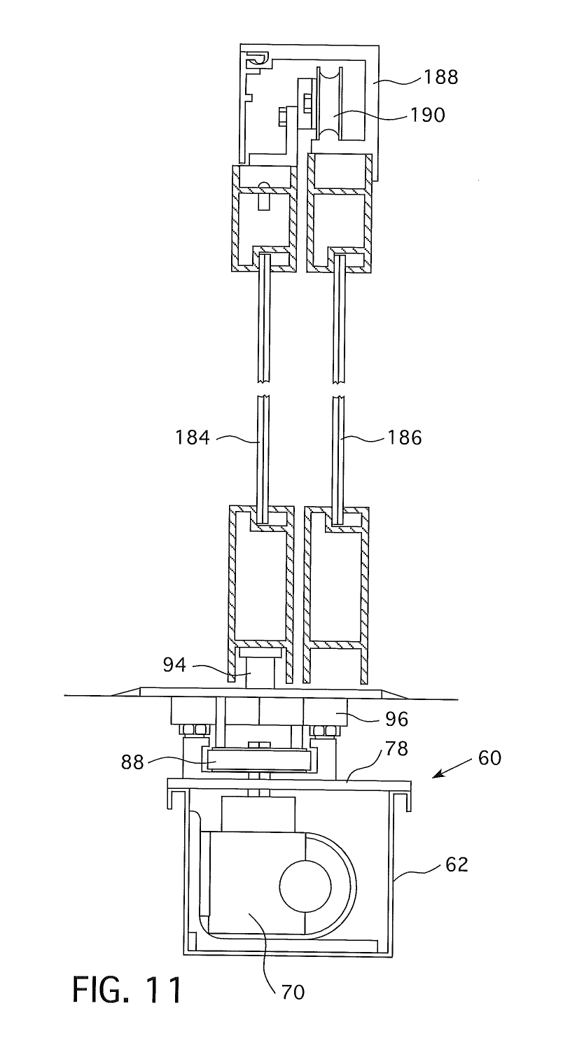

FIG. 11 is cross-sectional end view the operating assembly (60) shown in FIG. 7 in combination with a sliding door (184) and a fixed panel (186′). In other embodiments (not shown), the fixed panel (186′) may be replaced with a wall (not shown), a glass window (not shown), or other structural fenestration. The sliding door (184) is coupled to an overhead rail (188) by wheels (190) or linear activator. The fixed panel (186′) is attached below the overhead rail (188) by any fastener known to those skilled in the art.

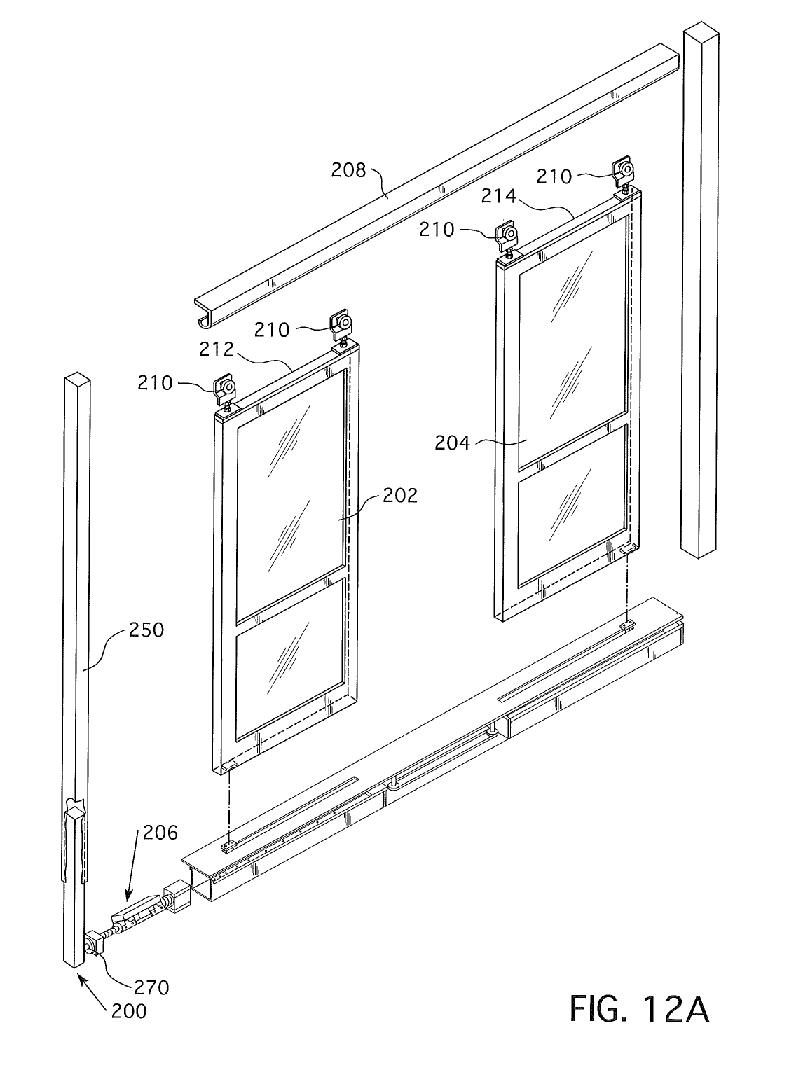

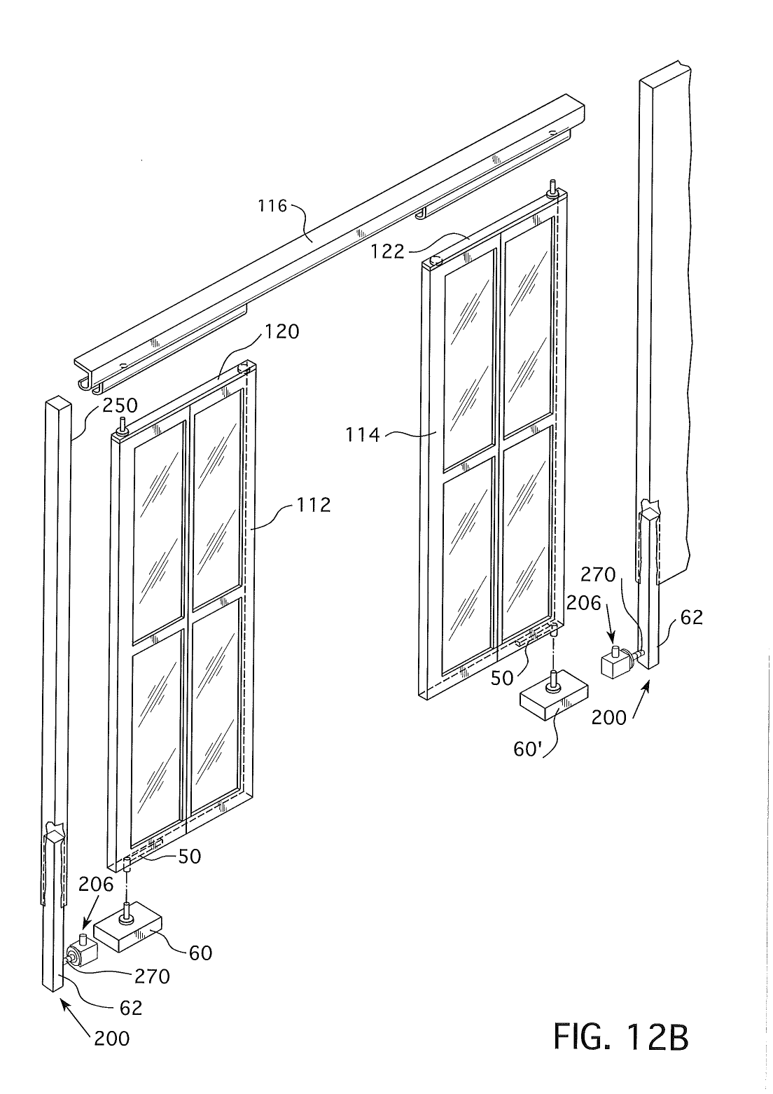

FIGS. 12A and 12B are exploded views of a door installation that includes a side mounted operating system (200). The operating system (200) includes all of the components included with operating system (60) described above and is placed within an enclosure such as enclosure (62) and then is mounted vertically within the side jamb (250) of the door frame or within an adjacent wall of the door frame (not shown).

FIG. 12A shows an embodiment of a side mounted operating system (200) in combination with a slider door (202, 204). As illustrated in FIG. 12A, spindle (270) extends laterally beyond the side jamb (250), below the floor surface, and engages a commercially available screw drive, linear actuator system (206). The operating system (200) activates the motor assembly in the same manner as the underfloor mounted unit described above with respect to FIG. 7, using a reversing motor to drive the linear actuator open and closed. Two sliding door panels (202) and (204) are coupled to a slide-type linear actuator at the heel of the door. The sliding doors are coupled to an overhead track (208) by way of wheels (210) or a linear actuator system (not shown). Breakaway arms (212) and (214) are provided at the top of the sliding door panels. In an alternate embodiment, side mounted operating system (200) is used in combination with a folding door (not shown).

In another alternate embodiment illustrated in FIG. 12B, spindle (270) extends laterally beyond the side jamb (250), below the floor surface, and engages a commercially available right angle power transmission system (206), which engages bottom pivot arm (50). The operating system (200) activates the motor assembly in the same manner as the underfloor mounted unit described above with respect to FIG. 12A, using a reversing motor to drive the right angle gear box open and closed. Two folding door panels (112, 114) are coupled to a bottom pivot arm (50) at the heel of the door. The folding doors are coupled to an overhead track (116) by way of a breakaway track and pivot system. Breakaway arms (120) and (122) are provided at the top of the folding door panels to permit the leading panel of the folding door to travel toward the pivoting panel when actuated. In alternative embodiments, the side mounted operating system (200) is used in combination with a single folding door (not shown) or a swinging door (not shown). When using the right angle power transmission system (206), a linear slotted track such as the one shown in the figures at (158) is not required. The embodiment illustrated in FIG. 12B is configured for use in conditions where the flooring is too shallow to accept an operating system such as operating system (60). In an embodiment, right angle power transmission system (206) has a low vertical profile. The embodiment illustrated in FIG. 12B does not require a floor cover such as the ones illustrated at (26) and (38) in the figures.

In one aspect, an improved retrofit conversion kit for converting a door operating apparatus from overhead use to underground use is disclosed that includes the addition of a sealing arrangement for protecting the door operating apparatus against moisture and/or dust encroachment within its underground location. In another aspect, a method for using this kit is disclosed. In an embodiment, the door operating apparatus which is to be retrofitted may be electromechanical or self-contained electrohydraulic, or is otherwise of a type that is generally intolerant to moisture. Also, in this embodiment, the door operating apparatus may be of a type that is designed for operation from a position other than the sub-floor stratum. Typically, the retrofit conversion kit is employed, for convening the door operating apparatus from overhead use to underground use and employs an enclosure to be mounted in the sub-floor stratum beneath the door, wherein all of the door operating apparatus is self-contained.

The problem solved by the operating assembly was not recognized in the prior art. It is disclosed herein that electronic and mechanical components of door operating apparatuses can be negatively affected if they are placed underground or within a floor. There is an enhanced likelihood that moisture or dust or both pan encroach into the mechanical components of the door operating apparatus or the electronic components of the door operating system or both if they are located underground or within a floor. This can cause the components to fail and can create a hazardous situation. Moving parts can corrode and become maintenance issues when not in a sealed environment.

A further surprising aspect of the operating assembly was the discovery that the addition of the sealing arrangement enhanced the mechanical performance properties of the device. The addition of the sealing arrangement to the retrofit conversion kit surprisingly provides enhanced lateral support to the spindle when a door coupled thereto experiences major lateral forces.

### Definitions

Door operating apparatus: A mechanism for opening and/or closing a door.

Automatic door operating system: Control elements for controlling a door operating apparatus, including electromechanical or electrohydraulic systems.

Enclosure: A container in which the door operating apparatus and automatic door operating system are enclosed.

Sub-Floor Stratum: Any stratum that is sufficiently proximal to a floor surface so as to be subject to moisture and/or dust conditions characteristic of a floor surface.

Spindle: A shaft protruding from the sub-floor mounted door operating apparatus that engages a bottom arm located in the bottom of the door panel. Conventionally, the spindle defines a “male” component mounted in the apparatus and the bottom arm includes a “female” component for achieving the engagement with the spindle. The spindle can be coupled to an adjustable chain sprocket, a drive belt pulley, or a geared direct drive, which, in turn, is coupled to an automatic door operator drive system for the provision of torque. The spindle can be mounted in a tapered bearing on a base plate and is laterally secured within a bushing on a top plate.

Door Arm: A structure or member attached to a door and capable of being coupled to a spindle for transmitting torque from the spindle to the door.

Spindle Housing: An assembly comprising a top plate with bushing, a base plate with a tapered bearing, and vertical support plates.

Mounting Sled: A structural support chassis to which the spindle housing, door operating apparatus, and automatic operator system are attached.

Sealing Ring: A cylindrical seal that is placed around a spindle and is positioned in a hole and bonded to a structure by means of a sealant for creating a seal therebetween against moisture and/or dust encroachment with respect to the interior of an enclosure.

Perimeter Gasket: A gasket, in embodiments made of vinyl or rubber, placed around the perimeter of an enclosure sandwiched between the flanges of upper and lower portions of the enclosure.

Splice Sealant: A sealant placed between any splices in the upper portion of an enclosure or in either the plate version of the threshold or the flooring version of the threshold. A preferred sealant is silicone.

Flooring Material: A material other than a threshold plate that is sometimes used in the area of the threshold to transition the interior and exterior flooring, while covering an enclosure. The flooring material is typically stone, tile, wood, carpet, or concrete, but can be made of other materials. The flooring material over the enclosure can be removable for service entry of the door operating apparatus.

While the foregoing has been set forth in considerable detail, it is to be understood that the drawings and detailed embodiments are presented for elucidation and not limitation. Design variations, especially in matters of shape, size and arrangements of parts may be made but are within the principles described herein. Those skilled in the art will realize that such changes or modifications of the invention or combinations of elements, variations, equivalents or improvements therein are still within the scope of the operating assembly as defined in the appended claims.

I claim:

1. An operating assembly for use with a door, comprising:
a motor assembly comprising a motor and a gearbox;
a drive spindle adapted to be rotated by the motor;
an enclosure adapted to house the motor assembly, wherein the enclosure is structured and arranged for positioning in a cavity in a surface of a floor; and
an actuator assembly, comprising:
a threshold sway track structured and arranged for attachment to a top surface of the floor and having opposed first and second ends and a slot that extends substantially along a length of the threshold;
an actuator track structured and arranged for attachment to the enclosure and having opposed first and second ends and a slot configured to receive a portion of the drive spindle;
a first converter positioned at the first end of the actuator track and coupled to the drive spindle;
a second converter positioned at the second end of the actuator track;
a drive element positioned in the slot of the sway track and structured and arranged for attachment to a bottom surface of the door; and
a transfer device that couples the first and second converters to the drive element;
wherein during operation the motor rotates the drive spindle and the first converter to move the transfer device to move the drive element along the slot of the sway track.

2. The operating assembly as in claim 1, further comprising a carrier structured and arranged for attachment to a fenestration and a top surface of the door to couple the door to the fenestration.

3. The operating assembly as in claim 1, further comprising a controller that is housed in the enclosure and that is coupled to the motor.

4. The operating assembly as in claim 1, further comprising a transformer that is housed in the enclosure and that is coupled to the motor.

5. The operating assembly as in claim 1, wherein the spindle is attached to the motor.

6. The operating assembly as in claim 1, wherein the first converter is a drive pulley, the second converter is an idler pulley, and the transfer device is a belt.

7. The operating assembly as in claim 1, wherein the first converter is a screw drive linear actuator, the second converter is a second screw drive linear actuator, and the transfer device is a screw drive linear actuator.

8. The operating assembly as in claim 1, wherein the door is a sliding door.

9. The operating assembly as in claim 1, wherein the door is a folding door.

10. An operating system, comprising:
a door; and
an operating assembly, comprising:
a motor assembly comprising a motor and gearbox;
a drive spindle adapted to be rotated by the motor;
an enclosure adapted to house the motor, wherein the enclosure is structured and arranged for positioning in a cavity in a surface of a floor;
a slotted threshold sway track structured and arranged for attachment to a top surface of the floor and having opposed first and second ends and a slot that extends along a portion of the threshold;
an actuator track structured and arranged for attachment to the enclosure and having opposed first and second ends and a slot configured to receive a portion of the drive spindle;
a first converter positioned at the first end of the actuator track and coupled to the drive spindle;
a second converter positioned at the second end of the actuator track;
a drive element positioned in the slot of the sway track and structured and arranged for attachment to a bottom surface of the door; and
a transfer device that couples the first and second converters to the drive element;
wherein during operation the motor rotates the drive spindle and the first converter to move the transfer device to move the drive element along the slot of the sway track to move the door.

11. The operating system as in claim 10, wherein the door is a sliding door.

12. The operating system as in claim 10, wherein the door is a folding door.

13. The operating system as in claim 10, further comprising a carrier structured and arranged for attachment to a fenestration and a top surface of the door to couple the door to the fenestration.

14. The operating system as in claim 10, wherein the first converter is a drive pulley, the second converter is an idler pulley, and the transfer device is a belt.

15. The operating system as in claim 10, wherein the first converter is a screw-drive linear actuator, the second converter is a second screw-drive linear actuator, and the transfer device is a screw-drive linear actuator.

16. An operating assembly for use with a door, comprising:
a motor assembly comprising a motor and a gearbox;
a drive spindle adapted to be rotated by the motor;
an enclosure adapted to house the motor, wherein the enclosure is structured and arranged for vertical positioning in a cavity in an adjacent structure;
an actuator assembly, comprising:
a slotted threshold sway track structured and arranged for attachment to a top surface of a floor and having opposed first and second ends and a slot that extends substantially along a length of the threshold;
an actuator track structured and arranged for attachment to the top surface of the floor and having opposed first and second ends and a slot configured to receive a portion of the drive spindle;
a first converter positioned at the first end of the actuator track and coupled to the drive spindle;
a second converter positioned at the second end of the actuator track;
a drive element positioned in the slot of the sway track and structured and arranged for attachment to a bottom surfaced of the door; and
a transfer device that couples the first and second converters to the drive element;
wherein during operation the motor rotates the drive spindle and the first converter to move the transfer device to move the drive element along the slot of the sway track.

17. The operating assembly as in claim 16, wherein the drive spindle extends laterally from the cavity in the adjacent structure.

18. The operating assembly as in claim 16, wherein the first converter is a screw-drive linear actuator, the second converter is a second screw-drive linear actuator, and the transfer device is a screw-drive linear actuator.

19. The operating assembly as in claim 16, wherein the door is a sliding door.

20. The operating assembly as in claim 16, wherein the door is a folding door.

21. The operating assembly as in claim 16, wherein the door is a swinging door.

22. An operating assembly for use with a door, comprising:
a motor assembly comprising a motor and a gearbox;
a drive spindle adapted to be rotated by the motor;
an enclosure adapted to house the motor, wherein the enclosure is structured and arranged for positioning in a cavity in an adjacent structure; and
an actuator assembly, comprising:
a spindle passing through a first hole of the enclosure to engage an arm of a transmission system positioned in a bottom surface of the door; and
a converter coupled to the spindle;
wherein during operation the motor rotates the drive spindle and the first converter to rotate the spindle to move the door between open and closed positions.

23. The operating assembly as in claim 22, wherein the door is a folding door.

24. The operating assembly as in claim 22, wherein the door is a swinging door.
